(19) United States
(12) Patent Application Publication
(10) Pub. No.: US 2024/0068913 A1
(43) Pub. Date: Feb. 29, 2024

(54) GAS AND SAMPLE EXTRACTION SYSTEM FOR HIGH-TEMPERATURE IRRADIATED SAMPLES OF MOLTEN SALT, RADIOPHARMACEUTICAL, TRITIUM GAS, AND NOBLE GAS PRODUCTION

(71) Applicant: Ohio State Innovation Foundation, Columbus, OH (US)

(72) Inventors: Matthew Van Zile, Columbus, OH (US); Lei Raymond Cao, Columbus, OH (US); Andrew Kauffman, Columbus, OH (US)

(21) Appl. No.: 18/456,656

(22) Filed: Aug. 28, 2023

Related U.S. Application Data
(60) Provisional application No. 63/401,424, filed on Aug. 26, 2022.

(51) Int. Cl. G01N 1/14; G01N 1/44

(52) U.S. Cl. CPC G01N 1/14; G01N 1/44; G01N 2001/1037

(57) ABSTRACT

An example extraction system includes a main body having a collar coupler for coupling to a pierceable portion of a container such that the first channel is in fluid communication with the pierceable portion when the container is coupled to the coupler, where the second body end defines a second channel extending such that the second channel is in fluid communication with the first channel; and a piston defining a piston channel extending from the first piston end to the second piston end, the piston including a hollow needle fluid communication with the piston channel, where the piston is slidably disposable within the second channel such that the hollow needle of the piston can extend through the first channel to pierce the pierceable portion of the container such that the container is in fluid communication through the hollow needle, the piston channel, and the second channel.

### CROSS-REFERENCE TO RELATED APPLICATIONS

This application claims the benefit of U.S. provisional patent application No. 63/401,424 filed on Aug. 26, 2022, and titled “GAS AND SAMPLE EXTRACTION SYSTEM FOR HIGH-TEMPERATURE IRRADIATED SAMPLES OF MOLTEN SALT, RADIOPHARMACEUTICAL, TRITIUM GAS, AND NOBLE GAS PRODUCTION,” the disclosure of which is expressly incorporated herein by reference in its entirety.

### STATEMENT OF GOVERNMENT SUPPORT

This invention was made with government support under DE-NE0009161 awarded by the Department of Energy. The government has certain rights in the invention.

### BACKGROUND

Radioactive substances can emit ionizing radiation that can damage materials and harm people and animals over time. Radioactive gasses can be particularly dangerous as they can be inhaled and spread quickly through the air. The challenges of working with radioactive substances are magnified when the work includes heating and/or performing chemical processing with those radioactive substances. Chemical processing and heating are important parts of researching radioactive substances, and can also be used to produce reagents for commercial and/or industrial processes. Tools for working with radioactive gasses are specialized, and can include combinations of internally contained structures (e.g., containment vessels) and sealing to contain and redirect radioactive gasses to prevent their exposure to people and the environment.

### SUMMARY

In some aspects, the techniques described herein relate to an extraction system, the system including: a main body having a longitudinal axis, a first body end, and a second body end opposite and spaced apart along the longitudinal axis from the first body end, wherein the first body end includes a collar coupler for coupling the main body to a pierceable portion of a container defining a container chamber, the first body end defining a first channel extending along the longitudinal axis toward the second body end such that the first channel is in fluid communication with the pierceable portion when the container is coupled to the coupler, wherein the second body end defines a second channel extending along the longitudinal axis toward the first body end such that the second channel is in fluid communication with the first channel; and a piston having a first piston end and a second piston end opposite and spaced apart from the first piston end, the piston defining a piston channel extending from the first piston end to the second piston end, the piston including a hollow needle extending from the first piston end and in fluid communication with the piston channel, wherein the piston is slidably disposable within the second channel such that, when the piston slides through the second channel toward the first body end, the hollow needle of the piston extends through the first channel to pierce the pierceable portion of the container such that the container chamber of the container is in fluid communication with the second body end through the hollow needle, the piston channel, and the second channel.

In some aspects, the techniques described herein relate to a system, wherein, when the main body is oriented such that the longitudinal axis is parallel to a gravitational axis and the first body end is below the second body end, the piston is slidable through the second channel toward the first body end by gravity.

In some aspects, the techniques described herein relate to a system, wherein the pierceable portion of the container is a foil cap.

In some aspects, the techniques described herein relate to a system, further including a containment vessel, the containment vessel including an opening configured to couple to the main body.

In some aspects, the techniques described herein relate to a system, further including a heater disposed within the containment vessel.

In some aspects, the techniques described herein relate to a system, wherein the containment vessel further includes a cooling jacket.

In some aspects, the techniques described herein relate to a system, further including a sensor disposed within the containment vessel.

In some aspects, the techniques described herein relate to a system, further including a tube disposed in the hollow needle of the piston.

In some aspects, the techniques described herein relate to a system, further including a rod disposed within the tube and configured to retrieve a sample from the container through the hollow needle of the piston.

In some aspects, the techniques described herein relate to a system, wherein the collar coupler includes two or more collar portions are movable radially inwardly to contact a portion of the container.

In some aspects, the techniques described herein relate to a method of processing a material, the method including: providing the material in a container, wherein the container includes a pierceable portion; coupling the container to a main body, wherein the main body includes a piston configured to pierce the pierceable portion of the container, the piston including a hollow needle; coupling the main body to a containment vessel; heating the container to produce a processed material; piercing the pierceable portion of the container using the piston; and retrieving the processed material.

In some aspects, the techniques described herein relate to a method, wherein the processed material includes tritium, and a radioactive salt.

In some aspects, the techniques described herein relate to a method, wherein piercing the pierceable portion of the container includes rotating the main body.

In some aspects, the techniques described herein relate to a method, wherein the main body is oriented so that the piston is pulled toward the pierceable portion of the container by gravity.

In some aspects, the techniques described herein relate to a method, wherein retrieving the processed material includes inserting a tube or wire through the hollow needle.

In some aspects, the techniques described herein relate to a method, wherein retrieving the processed material includes venting a gas through the hollow needle.

In some aspects, the techniques described herein relate to a method, wherein the method further includes purging the container.

In some aspects, the techniques described herein relate to a method, wherein purging the container includes adding an inert gas to the container.

In some aspects, the techniques described herein relate to a method, wherein the inert gas includes argon.

In some aspects, the techniques described herein relate to a method, further including cooling at least one of the main body, the container, or the material using a cooling jacket.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

FIG. 1 illustrates a system including a main body and piston, according to implementations of the present disclosure.

FIG. 2 illustrates a system including a main body, piston, and containment vessel, according to implementations of the present disclosure.

FIG. 3 illustrates a tube and rod configured to extract samples from a container through a piston and main body, according to implementations of the present disclosure.

FIG. 4 illustrates a method of processing a material, according to implementations of the present disclosure.

FIG. 5 illustrates an example capsule alignment holder, according to implementations of the present disclosure.

FIG. 6 illustrates an example outer irradiation vessel and crimped quartz capsule container that can be used in implementations of the present disclosure.

FIG. 7 illustrates a sample encapsulated using the outer irradiation vessel and crimped quartz capsule container shown in FIG. 6.

FIG. 8 illustrates a cross section of a system for heating a sample and extracting the sample from a sample vial, according to implementations of the present disclosure.

FIG. 9 illustrates a system including a containment vessel according to implementations of the present disclosure.

FIG. 10 illustrates an example tube for aligning and venting a sample capsule, according to implementations of the present disclosure.

FIG. 11 illustrates an example glovebox according to implementations of the present disclosure.

FIG. 12 illustrates an example high purity germanium detector with multi-channel analyzer according to implementations of the present disclosure.

FIG. 13 illustrates an example gravity rod, according to implementation of the present disclosure.

FIG. 14A illustrates a line drawing of a cross section of an example implementation of the present disclosure.

FIG. 14B illustrates a cross section of the example implementation shown in FIG. 14A.

FIG. 15A illustrates aluminum crimp caps, according to implementations of the present disclosure.

FIG. 15B illustrates example solid caps, according to implementations of the present disclosure.

FIG. 16A illustrates an example gasket, according to implementations of the present disclosure.

FIG. 16B illustrates an example flexible graphite gasket, according to implementations of the present disclosure.

FIG. 17 illustrates example properties of mica gaskets, according to implementations of the present disclosure.

FIG. 18A illustrates a first view of an example experimental configuration of a container, according to implementations of the present disclosure.

FIG. 18B illustrates a view of an example experimental configuration of the container of FIG. 18A including a cap and foil.

FIG. 18C illustrates a view of the example configuration of the container of FIG. 18A where the foil is positioned over the container.

FIG. 18D illustrates a view of the example configuration of the container of FIG. 18A where the cap and foil seal a fluid inside the container.

FIG. 18E illustrates a view of the example configuration of the container of FIG. 18D where the container is placed upright.

FIG. 19A illustrates an example leak test using 11 mm seals with heated vapor, according to implementations of the present disclosure.

FIG. 19B illustrates the results of the example leak test shown in FIG. 19A.

FIG. 20A illustrates an example heating profile within the containment vessel without cooling jacket water circulating for the implementation of the present disclosure shown in FIG. 8.

FIG. 20B illustrates an example heating profile within the containment vessel with cooling jacket water circulating for the implementation of the present disclosure shown in FIG. 8.

FIG. 21A illustrates an experimental implementation of a stainless steel jacketed container.

FIG. 21B illustrates a heating mechanism that can be positioned in the stainless steel jacketed container of FIG. 21A.

FIG. 21C illustrates the heating mechanism of FIG. 21B in the stainless steel jacketed container of FIG. 21A.

FIG. 22A illustrates a bottom view of a sample alignment holder and collar for locking in the sample vessel, according to implementations of the present disclosure.

FIG. 22B illustrates a perspective view of the sample alignment holder shown in FIG. 22A.

FIG. 23A illustrates a closed sample alignment collar, according to an example implementation.

FIG. 23B illustrates an open sample alignment collar, according to an example implementation.

FIG. 23C illustrates an example venting cylinder and needle, according to an example implementation described herein.

FIG. 23D illustrates an example venting needle with a fitted spacer, according to an example implementation described herein.

FIG. 23E illustrates an example perspective view of a venting cylinder.

FIG. 23F illustrates a perspective view of an example venting cylinder with a needle installed.

FIG. 24A illustrates a perspective view of a venting cylinder and needle with extraction tube inserted, according to implementations of the present disclosure.

FIG. 24B illustrates a illustrates a perspective view of the venting cylinder, needle, and extraction tube with a smaller extraction for alignment and insertion of extraction wire for sampling of FIG. 24A.

FIG. 24C illustrates an example alignment apparatus and venting cylinder and rod, according to implementations of the present disclosure.

FIG. 24D illustrates the venting cylinder disposed with the alignment apparatus, according to implementations of the present disclosure.

FIG. 24E illustrates a perspective view of the venting cylinder and needle in the dropped position where the needle would penetrate the sample container/vial.

FIG. 25A illustrates a flexible graphite gasket, aluminum foil, and crimp cap for sealing the sample container/vial according to implementations of the present disclosure.

FIG. 25B illustrates crimping a cap, foil, and grafoil together.

FIG. 25C illustrates attaching a capsule head into a holder with collar.

FIG. 25D illustrates closing an alignment collar around the capsule.

FIG. 25E illustrates tightening the alignment collar fasteners of FIG. 25D.

FIG. 25F illustrates positioning the venting cylinder with needle in the alignment tube.

FIG. 26A illustrates loading a venting needle into an alignment tube, using the implementation of the present disclosure shown in FIGS. 25A-25F.

FIG. 26B illustrates the venting needle and alignment tube of FIG. 26A aligned so that the force of gravity propels the venting needle through the foil cap.

FIG. 27A illustrates an experimental implementation including a containment vessel, according to implementations of the present disclosure.

FIG. 27B illustrates the containment vessel of FIG. 27A in an open position.

FIG. 27C illustrates inserting an alignment tube into the containment vessel of FIG. 27B.

FIG. 27D illustrates the alignment tube in the containment vessel of FIG. 27B.

FIG. 27E illustrates closing the containment vessel of FIG. 27B.

FIG. 27F illustrates the containment vessel of FIG. 27B in a closed position.

FIG. 28A illustrates the experimental implementation of FIGS. 27A-27F rotated 90 degrees.

FIG. 28B illustrates a venting cylinder/needle loaded into the alignment tube shown in FIG. 28A.

FIG. 28C illustrates the venting apparatus of FIG. 28B loaded and the vessel sealed with tri-clamp fittings horizontally.

FIG. 28D illustrates the containment vessel of FIG. 28C with the tri-clamp fittings attached.

FIG. 29A illustrates the containment vessel turned upright to allow the weighted piston to drop onto the sample vessel and pierce the capsule seal.

FIG. 29B illustrates venting the containment vessel shown in FIG. 29A.

FIG. 29C illustrates opening a center isolation valve to insert an extraction tube and sampling wire.

FIG. 29D illustrates sampling the capsule shown in FIG. 29C.

FIG. 30 illustrates monitoring the heating and pressure of an example containment vessel during an experiment.

FIG. 31 illustrates a cooling and processing system for radioactive gasses, according to implementations of the present disclosure.

FIG. 32 illustrates an experimental setup, according to implementations of the present disclosure.

FIG. 33A illustrates an aluminum crimp cap after 1 hour at 700 degrees Celsius based on the internal chamber temperature, according to implementations of the present disclosure.

FIG. 33B illustrates a grafoil gasket after 1 hour at 700 degrees Celsius based on the internal chamber temperature, according to implementations of the present disclosure.

FIG. 33C illustrates a second view of a grafoil gasket after 1 hour at 700 degrees Celsius based on the internal chamber temperature, according to implementations of the present disclosure.

FIG. 33D illustrates a third view of a grafoil gasket after 1 hour at 700 degrees Celsius based on the internal chamber temperature, according to implementations of the present disclosure.

### DETAILED DESCRIPTION

The devices, systems, and methods disclosed herein provide for a working containment system for heating and off-gassing of radioactive samples where the release of airborne radionuclides is expected. The devices, systems, and methods disclosed herein allow for at least 20 mL of sample material to be positioned within a sealed, high temperature furnace chamber with an alignment tube. The capsule is subsequently pierced and vented using a weighted cylinder fitted with a stainless steel air needle for controlled off-gassing and measurement. Furnace heating may be conducted during any stage of assembly but is recommended while the vessel is sealed with cooling water being supplied to the external cooling jacket. Temperatures may safely reach between 500-800 degrees centigrade with cooling water being supplied at room temperature.

Various implementations include a sample extraction system. The system includes a main body and a piston. The main body has a longitudinal axis, a first body end, and a second body end opposite and spaced apart along the longitudinal axis from the first body end. The first body end includes a collar coupler for sealingly coupling the main body to a pierceable portion of a container defining a container chamber. The first body end defines a first channel extending along the longitudinal axis toward the second body end such that the first channel is in fluid communication with the pierceable portion when the container is coupled to the coupler. The second body end defines a second channel extending along the longitudinal axis toward the first body end such that the second channel is in fluid communication with the first channel. The piston has a first piston end and a second piston end opposite and spaced apart from the first piston end. The piston defines a piston channel extending from the first piston end to the second piston end. The piston includes a hollow needle extending from the first piston end and in fluid communication with the piston channel. The piston is slidably disposable within the second channel such that, when the piston slides through the second channel toward the first body end, the hollow needle of the piston extends through the first channel to pierce the pierceable portion of the container such that the container chamber of the container is in fluid communication with the second body end through the hollow needle, the piston channel, and the second channel.

In some implementations, the coupler includes two or more collar portions are movable radially inwardly to contact a portion of the container.

In some implementations, when the main body is oriented such that the longitudinal axis is parallel to a gravitational axis and the first body end is below the second body end, the piston is slidable through the second channel toward the first body end by gravity.

In some implementations, the pierceable portion of the container is a grafoil seal.

In some implementations, the system further includes a jacket defining a jacket chamber and including a lid for sealing the jacket chamber. The jacket chamber is configured to support the main body and a container coupled to the coupler of the main body in a fixed position. In some implementations, the system further includes a heater disposed within the jacket. In some implementations, the system further includes one or more sensors disposed within the jacket chamber.

Implementations of the present disclosure can include a main body that positions a container that is sealed with a cap, and a piston with a needle that can pierce the container sealed with the cap to open the container. This can be used for safe processing of toxic or radioactive materials within the container, as the container can be vented without requiring a person to manually unseal the container.

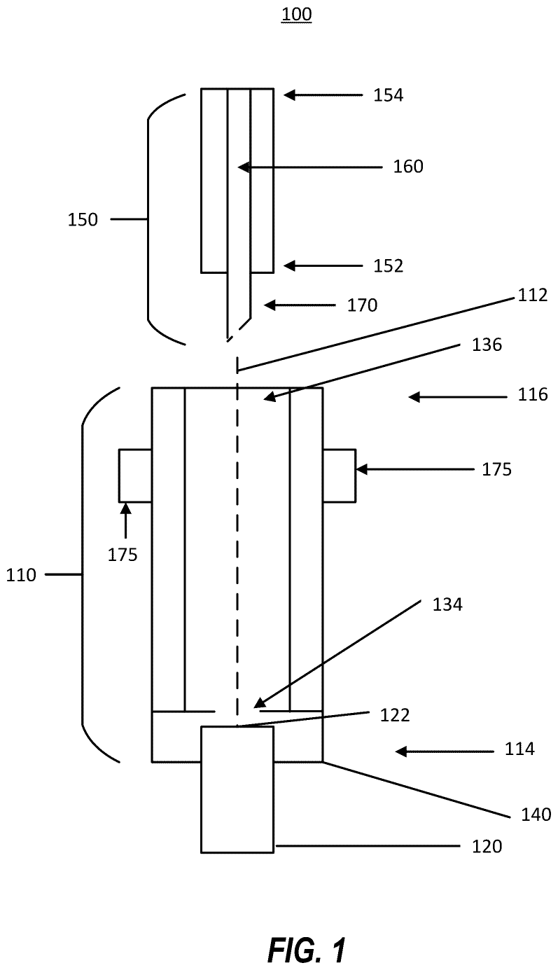

FIG. 1 illustrates a system 100 according to implementations of the present disclosure. The system 100 can include a main body 110. The main body 110 can include a longitudinal axis 112, a first body end 114, and a second body end 116 opposite and spaced apart along the longitudinal axis 112 from the first body end 114.

The first body end 114 can include a collar coupler for coupling the main body 110 to a container 120. The container can include a pierceable portion 122.

The pierceable portion 122 of the container 120 can optionally be a foil cap. A non-limiting example of a foil that can be used for the foil cap is an aluminum foil. Optionally, the pierceable portion 122 can be sealed to the container 120 using a grafoil material.

The first body end 114 can define a first channel 134 extending along the longitudinal axis 112 toward the second body end 116 such that the first channel 134 is in fluid communication with the pierceable portion 122 when the container 120 is coupled to the collar coupler 140. Optionally, the collar coupler can include two or more collar portions are movable radially inwardly to contact a portion of the container 120.

The second body end 116 can define a second channel 136 extending along the longitudinal axis toward the first body end 114 such that the second channel 136 is in fluid communication with the first channel 134.

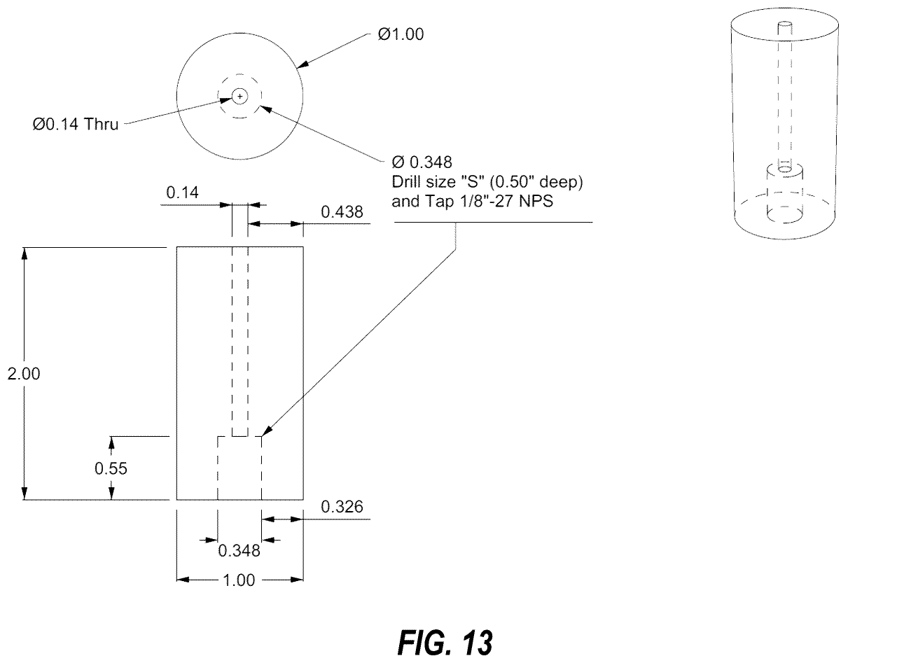

The system 100 can further include a piston 150. The piston 150 can have a first piston end 152 and a second piston end 154. As shown in FIG. 1, the first piston end 152 can spaced from the second piston end 154 and opposite to the second piston end 154. The piston 150 can include a piston channel 160 extending from the first piston end 152 to the second piston end 154, the piston including a hollow needle 170 extending from the first piston end 152 and in fluid communication with the piston channel 160. FIG. 13 illustrates an example gravity rod, according to implementation of the present disclosure.

Still with reference to FIG. 1, the piston 150 can be sized so that it fits within the second channel 136 of the main body 110. The piston 150 can be positioned so that it can slide within the second channel 136. The piston 150 can slide so that the hollow needle 170 contacts the pierceable portion 122 of the container 120. The hollow needle 170 can pierce the pierceable portion 122 of the container 120 to expose the inside of the container 120 to the piston channel 160. When the hollow needle 170 pierces the pierceable portion 122, any or all of the container 120, piston channel 160, and second channel 136 can be in fluid communication with one another.

Optionally, the system 100 can be operated by orienting the main body 110 so that the longitudinal axis 112 of the main body 110 is parallel to the gravitational axis (i.e, the main body 110 is positioned so that the hollow needle 170 of the piston 150 in the second channel 136 is pointed toward the ground). As used herein the term “gravitational axis” refers to the direction of the force of gravity. The force of gravity can then cause the piston 150 to slide through the second channel 136. Implementations of the present disclosure can be configured so that the force of gravity on the piston 150 is sufficient to cause the hollow needle 170 to pierce the priceable portion 122 of the container 120. Optionally, the needle 170 and/or combination of needle 170 and piston 150 can be referred to herein as a “gravity rod” (for example, the gravity rod shown in FIG. 13).

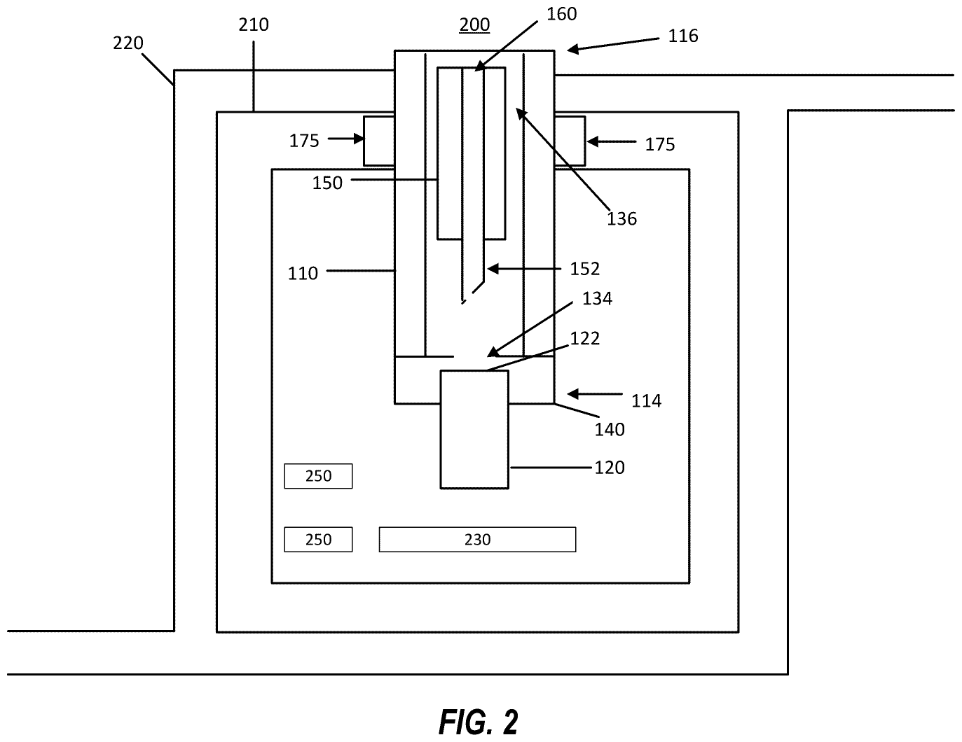

With reference to FIG. 2, a system 200 including the main body 110 and piston 150 of FIG. 1 disposed in a containment vessel 210. The main body 110 and piston 150 shown in FIG. 2 are described with reference to FIG. 1. The containment vessel 210 can be configured to couple to the main body 110. FIG. 1 and FIG. 2 illustrate a connector 175 for connecting the main body 110 to the containment vessel 210.

In some implementations, the containment vessel 210 can include a heater 230. The heater can be used to heat the container 120 and/or any materials inside the container 120.

In some implementations, the containment vessel 210 can include a cooling jacket 220. The cooling jacket can extend partially or completely around the containment vessel 210 and/or main body 110. The cooling jacket 220 can be configured to allow a coolant to flow through the cooling jacket to keep the outer surfaces of the containment vessel 210 from reaching temperatures that could damage components of the main body and/or containment vessel.

In some implementations, the containment vessel 210 can include one or more sensors 250. Non-limiting examples of sensors 250 that can be used include signal wires, temperature sensors, thermocouples, and/or pressure sensors.

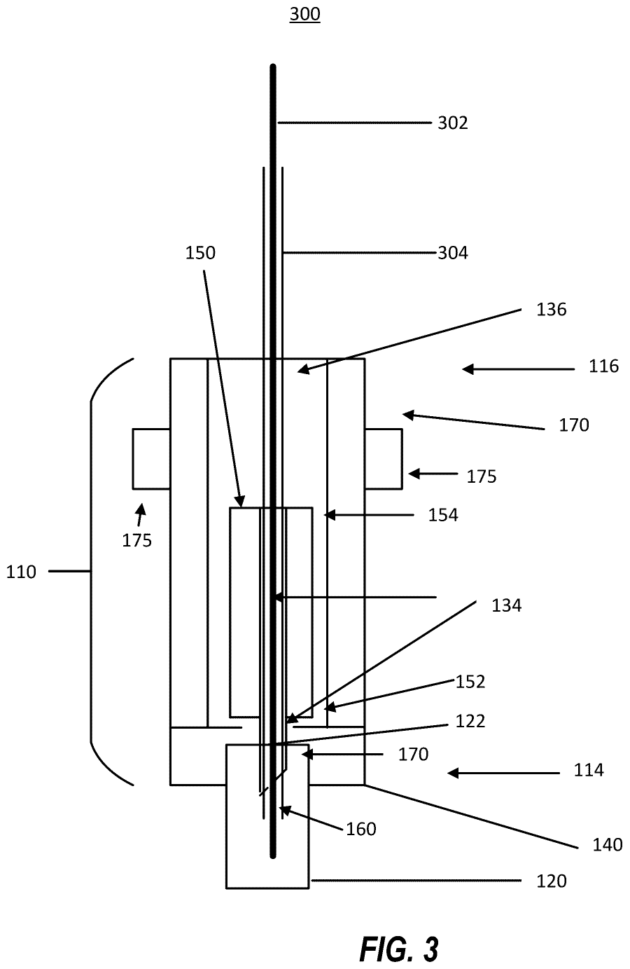

In some implementations, the system 100 can further include a rod and/or tube to collect samples from the container 120. FIG. 3 illustrates a system 300 including the system 100 shown and described in FIG. 1 with a rod 302 or wire and tube 304. FIG. 3 illustrates a configuration of the system 100 when the piston 150 and hollow needle 170 have been used to pierce the pierceable portion 122 of the container 120. In this configuration, the rod 302 and/or tube 304 can be inserted through the piston channel 160, the first channel 134, the second channel 136 and into the container 120. For example, in some implementations the container 120 can contain a gas and the rod may not be needed to extract the gas from the container. Alternatively or additionally, the container 120 may contain a solid and the rod 302 may be used with or without the tube 304 to extract a sample of the solid. Alternatively or additionally, the rod and/or tube may be used to extract liquids from the container. It should also be understood that any combination of the rod and/or tube can be used to extract any combination of liquids, solids, and gasses from the container 120, according to various implementations of the present disclosure.

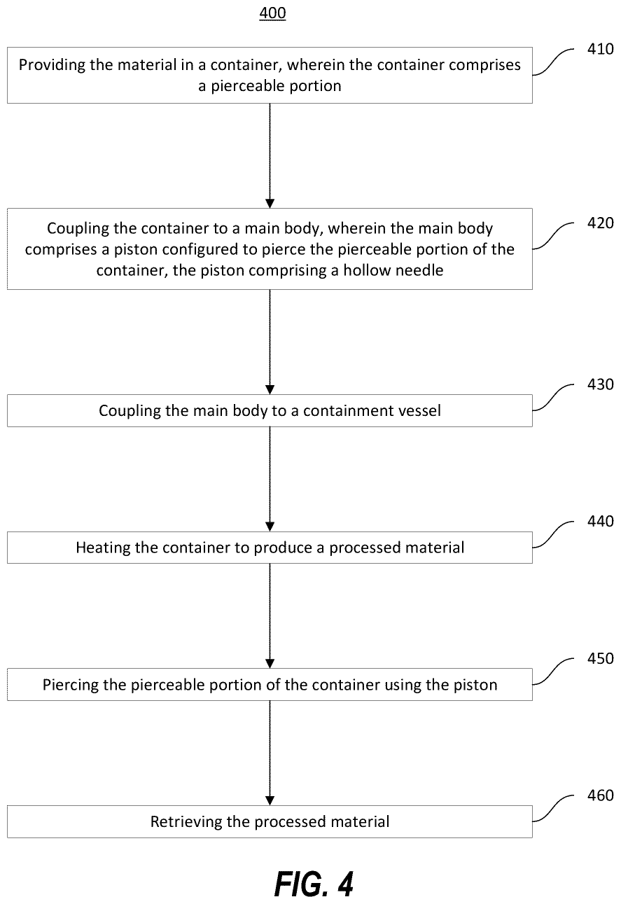

With reference to FIG. 4, a method 400 of processing a material according to implementations of the present disclosure is shown. The method 400 can be performed using the systems 100, 200, 300 shown and described with reference to FIGS. 1-3.

At step 410, the method includes providing the material in a container, where the container includes a pierceable portion.

At step 420 the method includes coupling the container to a main body, wherein the main body comprises a piston configured to pierce the pierceable portion of the container, the piston comprising a hollow needle

At step 430 the method includes coupling the main body to a containment vessel.

At step 440 the method includes heating the container to produce a processed material. In some implementations, the method 400 can further include cooling the main body, the container, and/or the material using a cooling jacket. The cooling jacket can circulate a liquid or gas near the main body, container and/or material to cool any/all of the parts of the system.

At step 450 the method includes piercing the pierceable portion of the container using the piston. In some implementations, the piston can be caused to pierce the piercable portion of the container by the force of gravity. The main body can be turned so that gravity pulls the piston toward the container. Optionally, this can include rotating the main body so that the main body is positioned with the piston above the container.

At step 460 the method includes retrieving the processed material. In some implementations of the present disclosure, the method 400 can be used to generate tritium and the processed material can be tritium. Alternatively or additionally, the method 400 can be used to liquefy a radioactive salt, and the processed material can be the radioactive salt. The processed material can be retrieved at step 460 by inserting a tube and/or wire through the hollow needle of the piston to remove the processed material from the container. Optionally, gasses can be vented through the hollow needle of the piston.

In some implementations, the method can include purging the container using a gas. Optionally, the gas can be introduced through a tube inserted into the container. The gas can be an inert gas, and a non-limiting example of an inert gas that can be used in some implementations is argon.

### Example 1

Example implementations of the present disclosure were designed, built and tested.

An example implementation includes a radioactive tracer dilution (RTD) application for mass determination of irradiated fuel-bearing molten salt for nuclear material control and accounting (MC&A) scenarios. The irradiation experiment can be designed for a fuel-bearing chloride salt sample mixed with a radioactive tracer (²²Na) of known activity and used for sampling the mixture for activation analysis.

The ²²Na is an effective radioactive tracer to test the RTD concept [1]. This tracer was chosen because it undergoes beta+decay and is mainly produced by ²⁴Mg(d,α)²²Na reaction with an accelerator and a specific target. There can be two possibilities from which ²²Na might be produced in a fission system, such as the double reactions, ⁶Li(n,α)³H and ²⁰Ne(³H,n)²²Na, which, however, has an extremely low yield in a fission reactor. The ²²Na radioisotope could also be produced by spallation of argon gas, which, is more likely in nuclear detonation scenarios.

The radioisotope ²²Na has known chemical compatibility with actinides and fission products in molten salt chloride and fluoride salts; it emits a 1274.54 keV gamma-ray that can be outside of the Compton plateau of many fission products. A known challenge is that it has an identified overlapping peak at 1274.43 keV from 154Eu. This interference can be resolved by measuring other gamma peaks from 154Eu, from which the ²²Na gamma peak counts can be determined with the help of known branching ratio of 154Eu decay. However, there may be unknown interference if it is a real fission spectrum, which can only be investigated by irradiating a fuel-bearing salt to introduce fission products. It should be understood that the equipment and procedures described herein can be used to monitor and evaluate any types of fission gas production, off-gassing processes, and capture, and that the specific gasses, off-gassing processes, and systems and methods of fission gas production/capture discussed with reference to the present example are only non-limiting examples.

Implementations of the present disclosure include methods of salt preparation. A 13.8 g of MgCl₂—KCl—UCl₃ (DU) fuel salt was prepared. High purity (99.99%) MgCl₂ and KCl were acquired through commercial vendors and mixed with a 0.3:0.7 molar ratio in terms of MgCl₂:KCl. The UCl₃ salt was synthesized by using DU metal rods and FeCl₂ in MgCl₂—KCl at ˜500° C. Salt samples were taken and measured by ICP-MS, and the UCl₃ concentration was determined to be 15.15 wt % with ²³⁵ U concentration at 0.07 wt % and ²³⁸U concentration at 10.38 wt %. The FeCl₂ concentration was 0.045 wt %. The total uranium in the sample had an overall average of 10.45 wt %. Following these measurements, the MgCl₂—KCl—UCl₂ salt mixture was packed in an argon glovebox and shipped.

Implementations of the present disclosure include methods of molten salt processing with off-gassing capabilities.

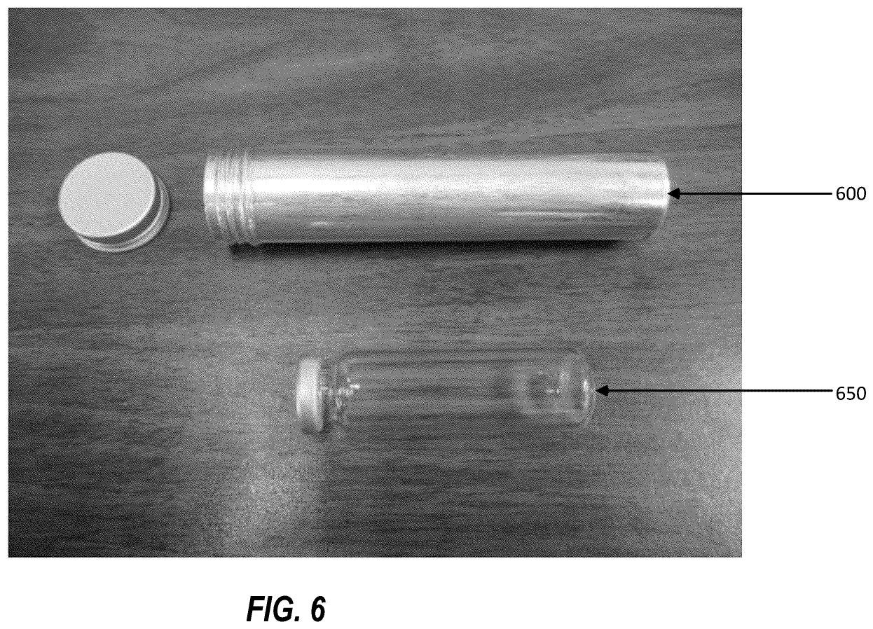

Implementations of the present disclosure include salt irradiation capsules that can be used as containers for the different materials and/or samples described herein. FIG. 6 illustrates an outer aluminum irradiation vessel 600 and a crimped quartz capsule 650.

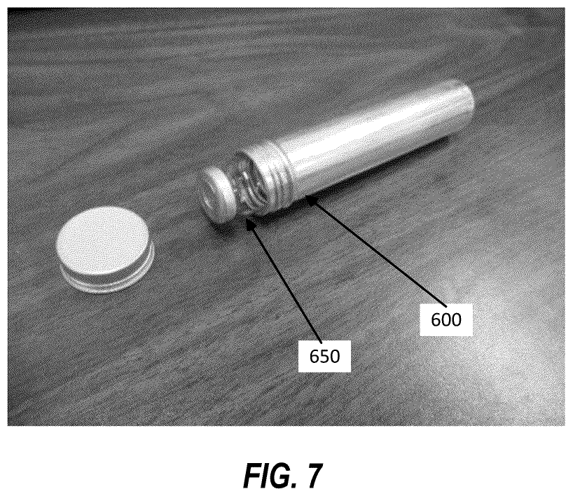

The irradiation capsules for holding the solid and molten fuel salt mixture during post-irradiation heating can be designed with high purity fused quartz (99.98% SiO₂) body which can be sealed with a flexible graphite gasket or Grafoil (GHL 2030L) with a minimum 99% carbon weight percentage. FIG. 7 illustrates the crimped quartz capsule 650 of FIG. 6 inserted into the outer aluminum irradiation vessel 600 of FIG. 6. The seal and capsule are held together with an aluminum crimp cap rated for 45 psi release pressure. Using the ideal gas law (Equation 1), it was determined that the maximum pressure increase of 6 mL of argon gas in the remaining cavity space of the bottle would not exceed 24 psi above atmospheric with a temperature increase of 130° C., that is, an increase from 20° C. to 150° C.

PV=nRT (1)

The maximum temperatures observed in the designated irradiation facility due only to reactor core heating have been shown not to exceed 110° C. at full power (450 kWₜₕ). The melting point of the eutectic mixture of fuel salt has been determined to be approximately 430° C., which means the salt will remain solid during the irradiation period.

Conservative estimates of the salt activity levels for 10 grams of mixture were calculated and dose rates for gamma radiation were determined to be <30 mrem/hr at 10 cm from the source after 64 hours post-irradiation. Dose rates for beta radiation are estimated to be much higher but can be easily contained and shielded to prevent harm to personnel.

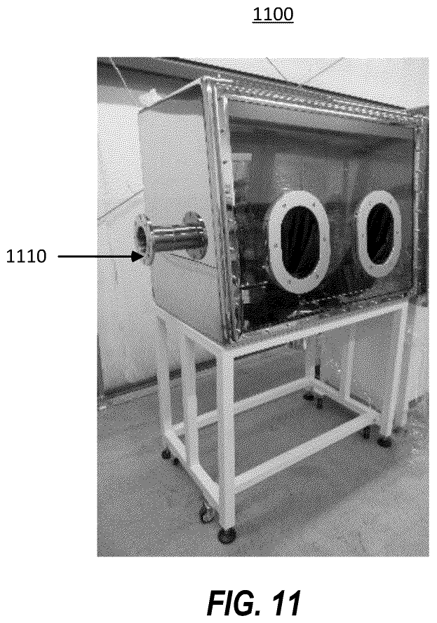

Once the activity levels are deemed safe, the capsule can be transferred to the glovebox where gamma spectra will be collected at 10 days and 100 days after irradiation. An example glovebox is shown in FIG. 11. For the first experiment, the capsule can remain sealed. A HPGe gamma-ray detector can be connected through a side port of the glovebox to measure the irradiated salt as well as the fission gas activities.

After obtaining the salt gamma spectra, the subsequent experiments can focus on evaluating the RTD method. A salt sample containing the tracer can be irradiated using the same process in solid form. After irradiation, the capsule can be transferred to an airtight containment and heating vessel in the argon environment within a glovebox. The containment system can be designed so that the vessel may be rotated 90 degrees to allow a venting needle attached to a weighted piston necessary to drop onto the capsule head and puncture the seal for releasing gaseous fission products or vapor.

The released fission product gases, if any, will be vented through an off-gassing line to a decay tank outside the glovebox that will be kept at negative pressure. Activity of the entire sample will be measured. A line cooled with liquid nitrogen will serve as a cold trap to condense the fission product gases and a significant portion of the argon gas. The boiling points for xenon and krypton are −107.1° C. and 153.4° C. respectively while the liquid nitrogen will be held below −200° C. to condense and isolate the gases.

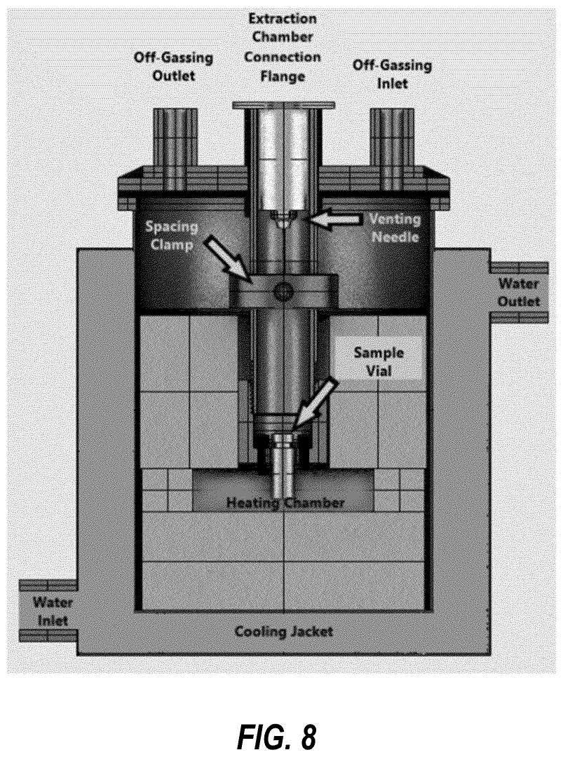

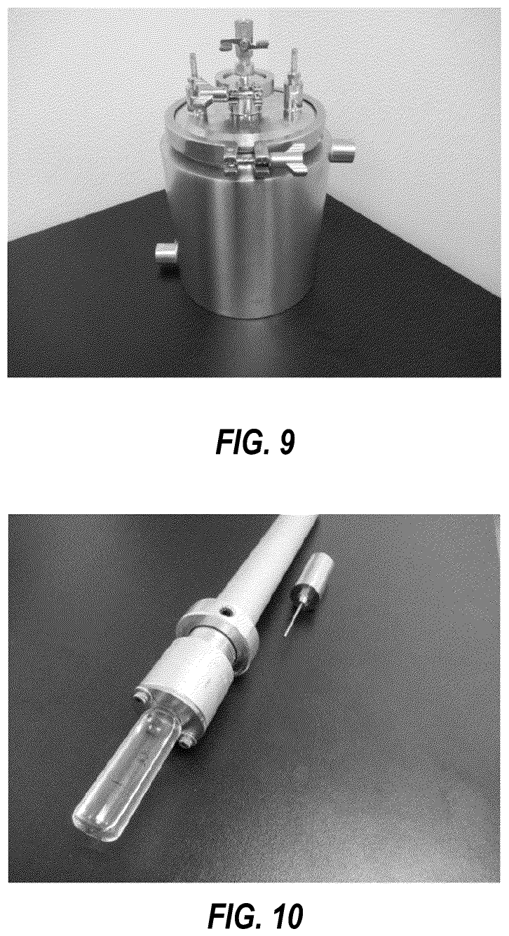

Once the off-gassing process is complete with possible fission product gases measured and analyzed, the salt sample will then be heated to 450° C. using a small heating plate (e.g., a kiln sold under the trade name Ultralite) situated within a containment vessel (FIG. 8). FIG. 9 illustrates a perspective view of an example containment vessel. The kiln is capable of reaching up to 850° C. at 250 W with 120 VAC. The internal temperature of the tube can be controlled and monitored with an external power supply and controller which includes over-temperature protection. In addition, a water-cooled jacket is included in the design to prevent overheating the glovebox, regulate pressure within the vessel, and preserve the integrity of all sealing gaskets and valves.

When the fuel salt mixture has melted, the venting system can be cycled a second time to flush out any remaining fission gases from the salt. These gases can be measured and analyzed. The system can be flushed with fresh argon, the central valve will be opened, and an extraction wire can be inserted through the venting piston and needle using a guide tube specially machined to mate with the topmost section of the weighted piston. FIG. 10 illustrates an example tube for aligning and venting a sample capsule.

Afterwards, a small sample of the salt can be taken from the capsule and its mass and activity will be measured. Using Equation 2, the mass of the original fuel salt mixture (assumed unknown) can be determined through the RTD method.

$${Mass}_{tot} = ( \frac{{A}_{1}}{{A}_{2}} ) * {Mass}_{sample} \qquad ( 2 )$$

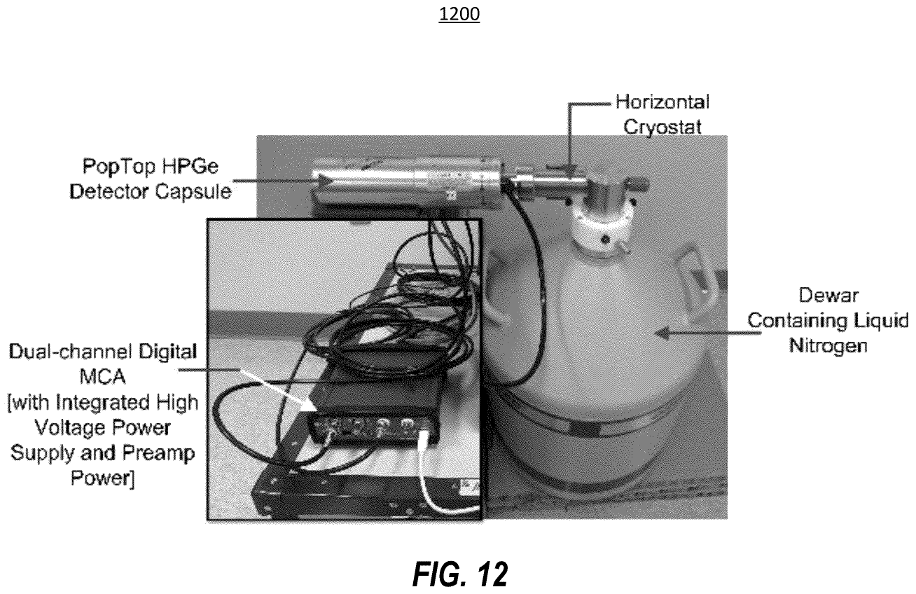

A customized glovebox 1100 is illustrated in FIG. 11 including a gamma ray measurement port 1110 that has been installed to measure the gamma spectrum of the irradiated salt inside the glovebox 1100, along with the gamma spectrum from the fission gas. Gamma spectroscopy of the irradiated salt can be performed using the High Purity Germanium (HPGe) detector (ORTEC GEM 15P4-70 Coaxial P-type), as illustrated in the system 1200 of FIG. 12, with a useful energy range of 40 keV to 10 MeV. The probe for the detector can be mounted in the measuring port directly adjacent to the work area within a glovebox.

In the study, the initial burn-up analysis was performed using the Oak Ridge Isotope GENeration (ORIGEN) and Monte-Carlo N-Particle transport (MCNP) codes. The simulation utilized flux information from the Ohio State University Research Reactor (OSURR) auxiliary irradiation facility (AIF) where the salt will ultimately be irradiated. After an irradiation time of 1 hour and cool down of 3 days, the results of the simulation indicated that the burnup of the ²²Na tracer was 0.05% of the original 10 μCi added to the fuel-bearing salt. In comparison, MCNP determined a 0.025% burnup of ²²Na after the same period. This result indicates that the tracer will retain sufficient activity for gamma spectrum analysis. Monitoring the production of additional radioactive isotopes can also be performed in the simulation, for example the production of fission products gases and isotopes that would cause spectral interference to the ²²Na gamma peak. This analysis can provide an expectation of the type and amount of fission gases that would be released during the off-gassing process. ORIGEN shows timestamps for the production and decay of isotopes from start of irradiation through the 3-day decay period; an expected level of both stable and radioactive gases can be summed together. As the initial irradiation of the salt will be done in its solid phase, the solubility of gases in the solid salt was considered. MCNP simulations involving CINDER90 were used to determine quantities and activity levels following irradiation. As used herein, the following abbreviations are used:
m 1=mass after 1 hour irradiation
m 2=mass after 3 days decay
A₁=activity after 1 hour irradiation
A₂=activity after 3 days decay.

The studied MCNP calculations were based on 100 cycles with 10⁷ particles per sample. Flux values in the sample were determined to be 2.0×10¹³ n/cm²/sec with an error of 1.49% within a volume of 4.119 cm³ for 1 hour at 450 kWₜₕ. Isotopes of interest were noted including 154Eu which shares a gamma energy around the same 1274.54 keV peak as the ²²Na tracer. The expected quantity of ¹⁵⁴Eu after a 1-hour burn would be equivalent to 3.8×10⁻¹⁷ grams producing an approximate activity of 1×10⁻⁵ μCi.

Calculations using 10 micrograms of ²²Na tracer proved to be much higher in activity levels than necessary. Therefore, another burn-up analysis was conducted with MCNP using an initial quantity of 0.016 micrograms. This resulted in 1.596×10⁻⁸ grams with an activity of 99.7 μCi after 3 days. This activity level was deemed to be much more manageable for post-irradiation analysis. Guided by these results, the amount of ²²Na tracer to be added in the actual irradiation experiment could be greatly reduced.

### Example 2

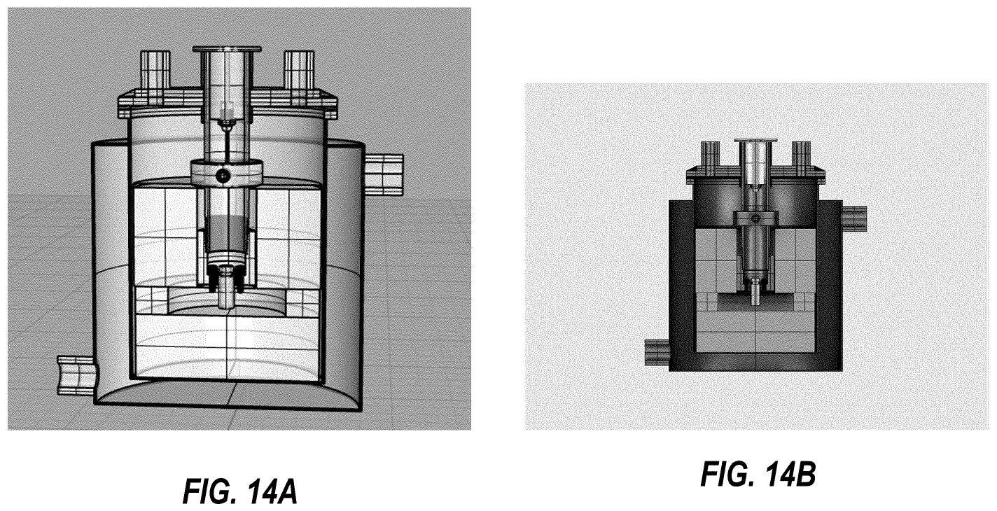

FIG. 14A illustrates a line drawing of a cross section of an example implementation of the present disclosure. FIG. 14B illustrates a cross section of the example implementation shown in FIG. 14A. The example implementations shown in FIGS. 14A and 14B can be used for heating, venting and sampling small scale (10-20 mL) radioactive samples. The cooling jacket can be included for preserving integrity of sealing components (i.e. gaskets and hoses).

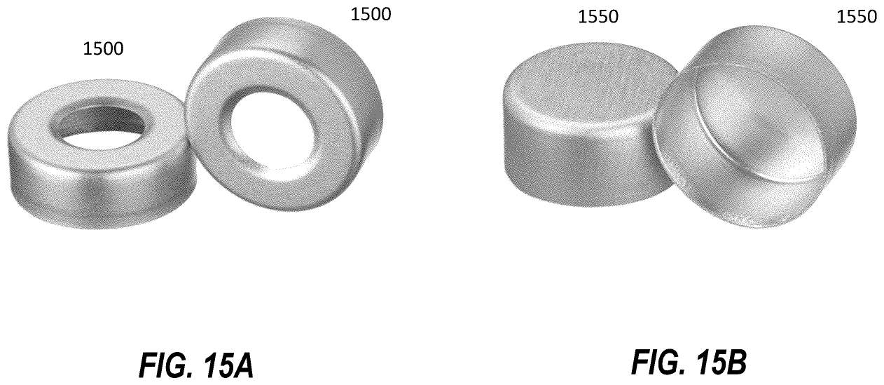

FIG. 15A illustrates aluminum crimp caps, and FIG. 15B illustrates 20 mm solid caps. In some implementations, a pressure increase in a container is about 21 psi during a temperature rise from 20 degrees Celsius to 150 degrees Celsius, when about 1 ml of argon is in the container.

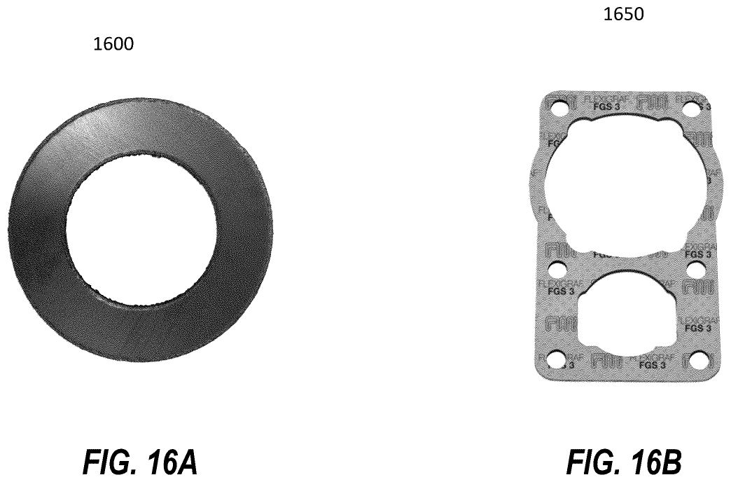

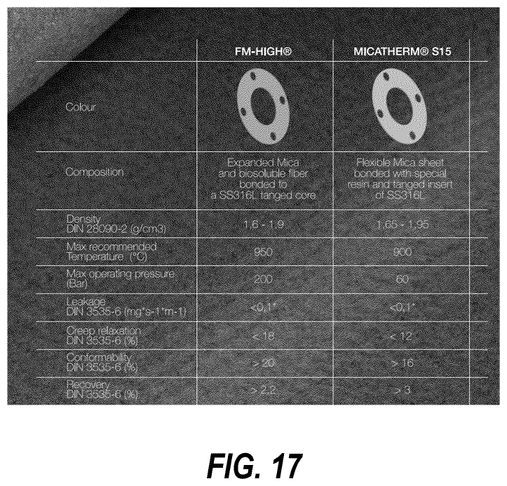

The aluminum crimp seals 1500 and/or solid caps 1550 can be sealed using gaskets. An example gasket 1600 is shown in FIG. 16A. Optionally, the gasket can be a Mica gasket sold under the tradename MicaTherm with a maximum temperature of about 900 degrees Celsius in oxygen. Alternatively or additionally, the gasket can be a flexible graphite gasket with a maximum temperature of about 450 degrees Celsius in oxygen, or 2980 degrees Celsius in argon. Example properties of mica gaskets are shown in FIG. 17, with an example maximum pressure of 870 psi. An example flexible graphite gasket 1600 is shown in FIG. 16A. FIG. 16B illustrates another example flexible graphite gasket, according to implementations of the present disclosure.

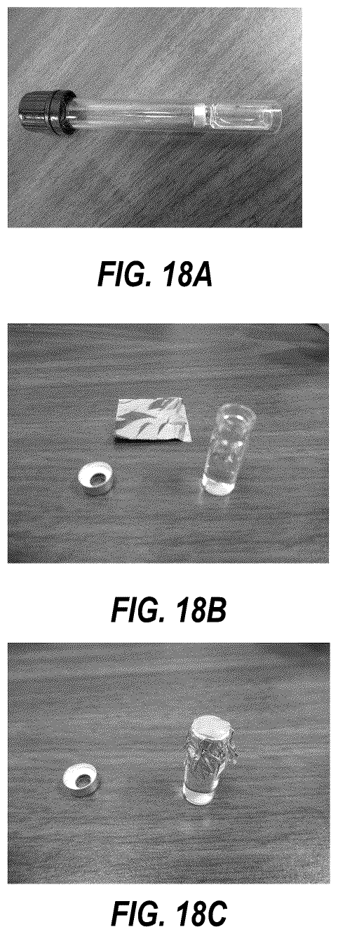

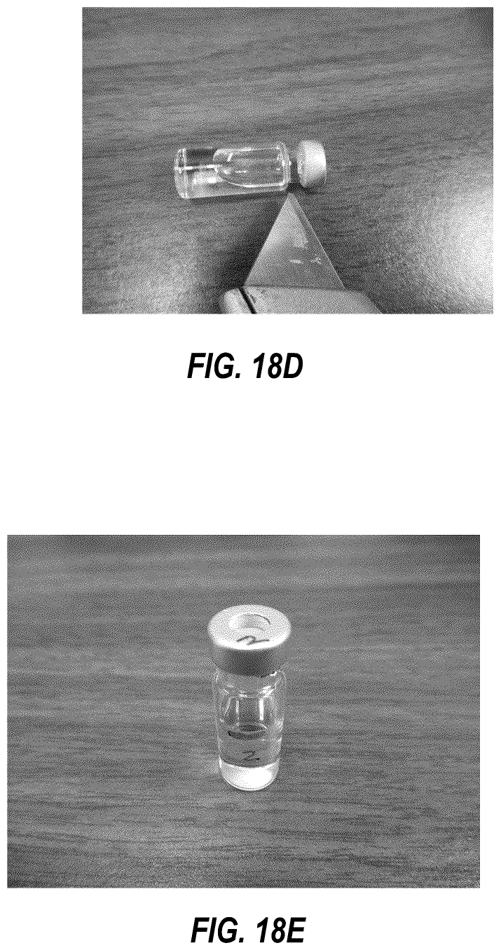

FIGS. 18A-18E illustrate example experimental configurations of a container, according to implementations of the present disclosure.

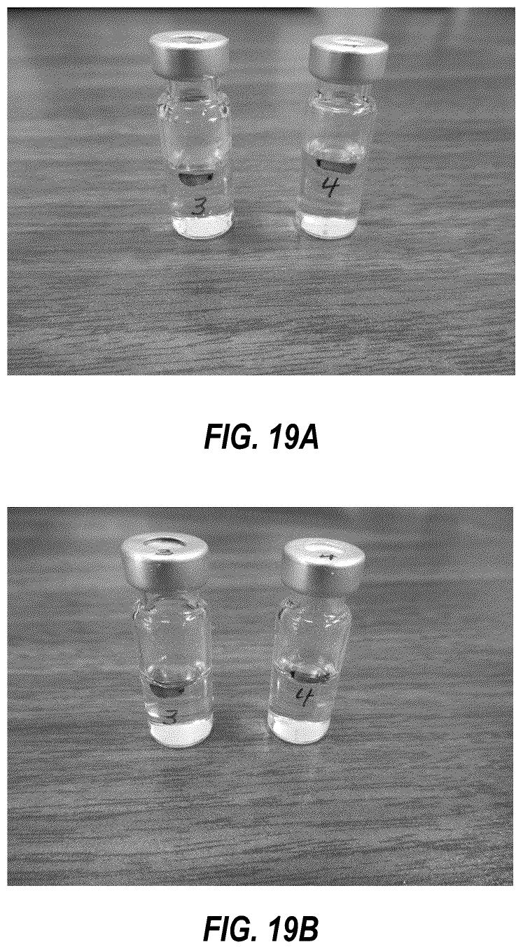

FIG. 19A illustrates an example leak test using 11 mm seals with heated vapor. FIG. 19B illustrates the results of the example leak test shown in FIG. 19A.

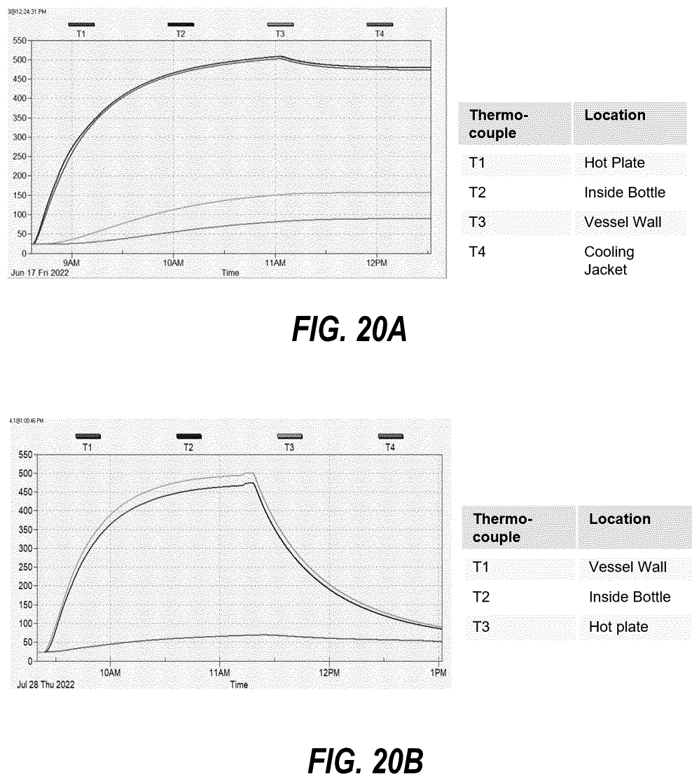

FIG. 20A illustrates experimental heating results without cooling jacket water circulating for the implementation of the present disclosure shown in FIG. 8.

FIG. 20B illustrates experimental heating results with cooling jacket water circulating for the implementation of the present disclosure shown in FIG. 8.

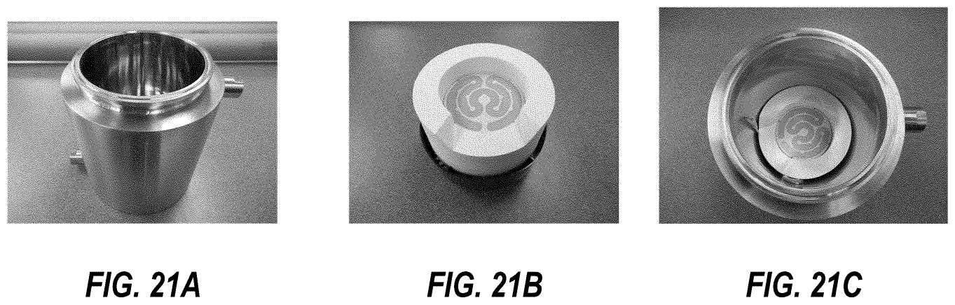

FIG. 21A illustrates an experimental implementation of a stainless steel jacketed container. FIG. 21B illustrates a heating mechanism that can be positioned in the stainless steel jacketed container of FIG. 21A. FIG. 21C illustrates the heating mechanism of FIG. 21B in the stainless steel jacketed container of FIG. 21A.

The experimental implementation of a stainless steel jacketed container and heating mechanism shown in FIGS. 21A-21C can include the following characteristics:
Stainless Steel Jacketed Container: 5.75″ I.D. 8″ Deep.
Cooling fittings: ½″ NPT hose Tri-clamp lid.
Center Tube: 1.365″ I.D. Gas fittings: ¼″ NPT hose
Resistance heater-hot plate: Max Temp: 840 C (1550 F) Voltage: 120 VAC

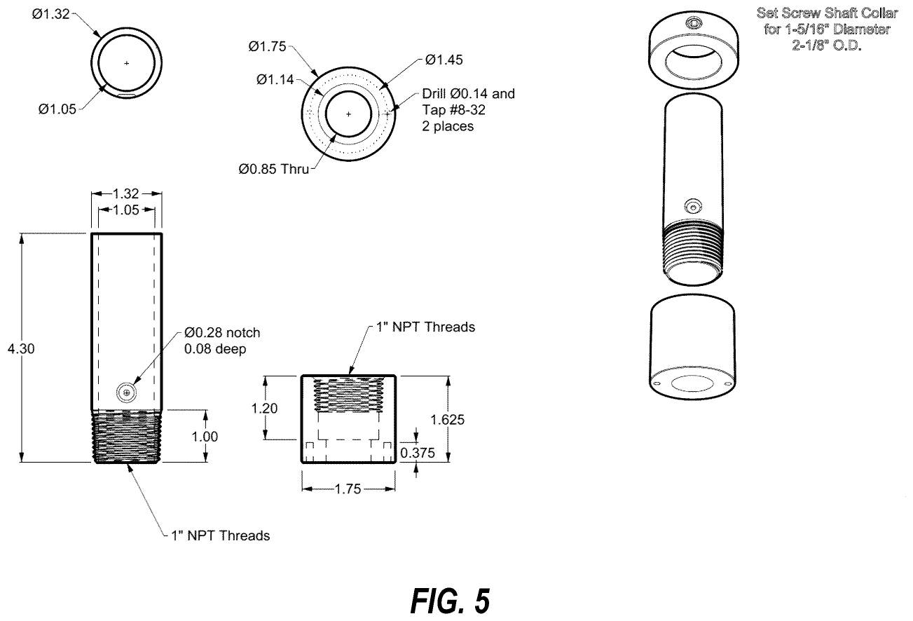

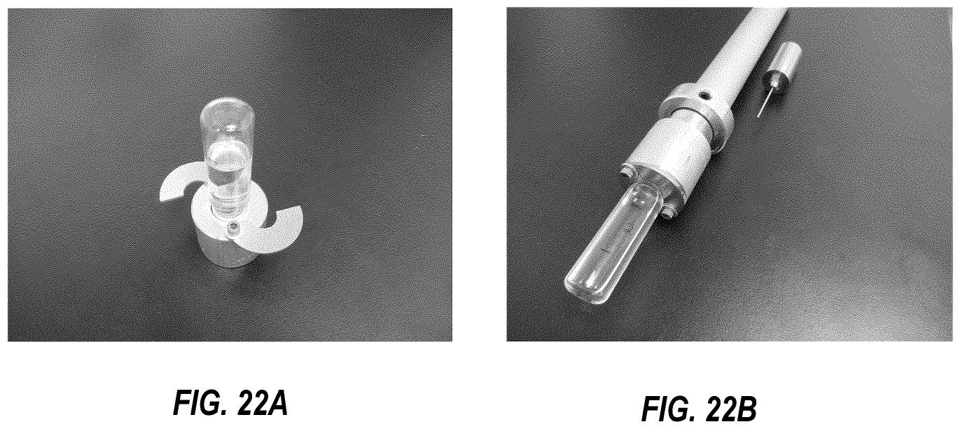

The experimental implementation included a sample alignment holder with venting mechanism (also referred to herein as a “capsule alignment holder” or a collar coupler”). FIG. 5 illustrates another example of a capsule alignment holder that can be used with implementations of the present disclosure. FIG. 22A illustrates a bottom view of the sample alignment holder, and FIG. 22B illustrates a perspective view of the sample alignment holder.

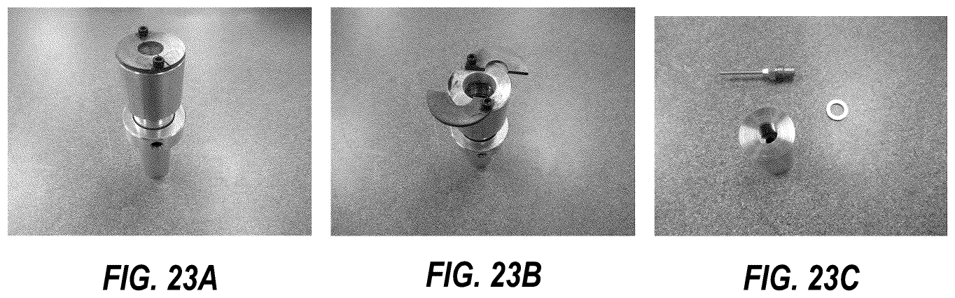

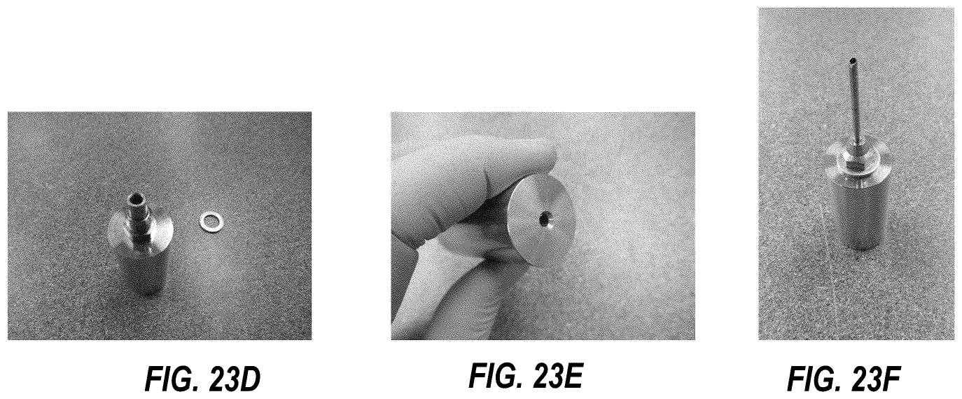

FIG. 23A illustrates a closed sample alignment collar, according to an example implementation. FIG. 23B illustrates an open sample alignment collar, according to an example implementation. FIG. 23C illustrates an example venting cylinder and needle, according to an example implementation described herein. FIG. 23D illustrates an example venting needle with a fitted spacer, according to an example implementation described herein. FIG. 23E illustrates an example perspective view of a venting cylinder. FIG. 23F illustrates a perspective view of anan example venting cylinder and needle.

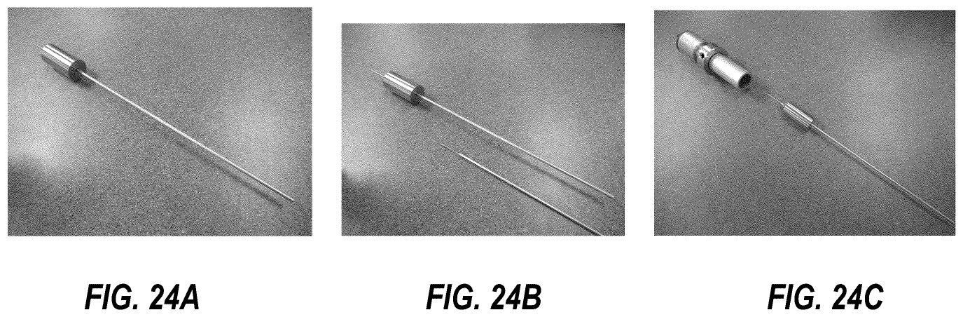

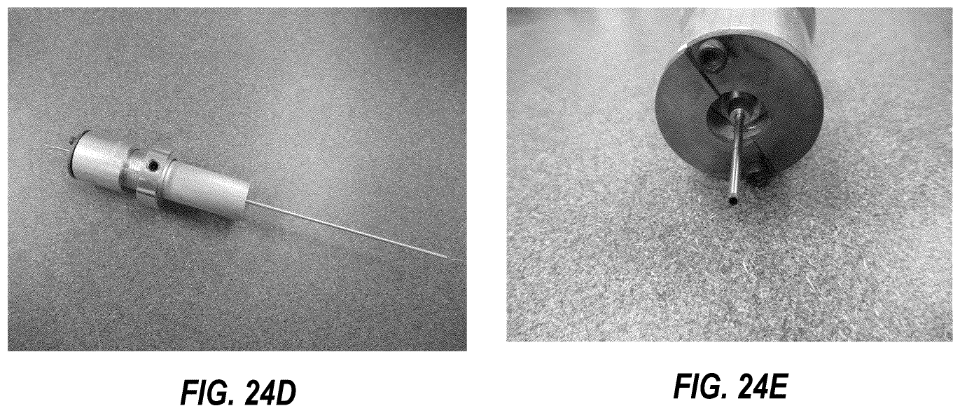

The experimental implementation also included a venting and alignment apparatus for sampling within a central tube. FIG. 24A illustrates a perspective view of the venting cylinder and needle. FIG. 24B illustrates a illustrates a perspective view of the venting cylinder, needle, and rod. FIG. 24C illustrates an example alignment apparatus and venting cylinder and rod. FIG. 24D illustrates the venting cylinder disposed in the alignment apparatus. FIG. 24E illustrates a perspective view of the venting cylinder and needle.

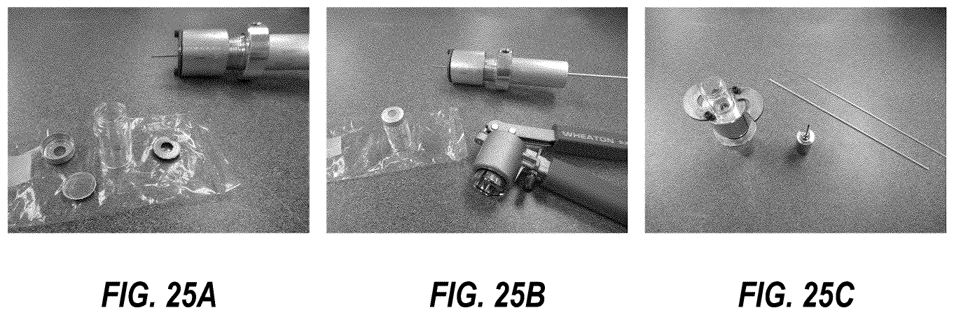

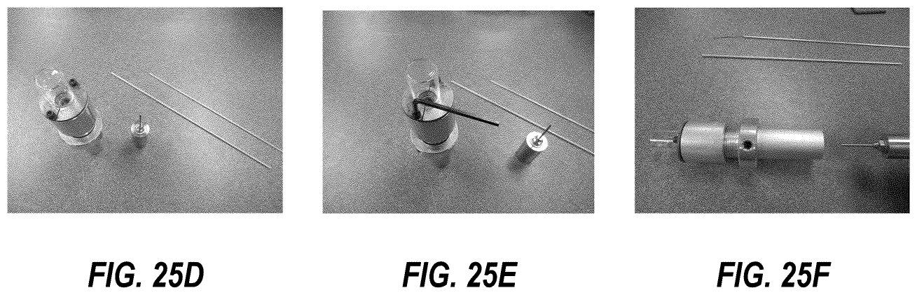

The study described herein included a test of piercing a foil seal using the force of gravity. FIG. 25A illustrates a flexible graphite gasket, aluminum foil, and crimp cap for sealing the sample container/vial. FIG. 25B illustrates crimping a cap, foild, and grafoil together. FIG. 25C illustrates attaching a capsule head into a holder. FIG. 25D illustrates closing an alignment collar around the capsule. FIG. 25E illustrates tightening the alignment collar fasteners. FIG. 25F illustrates positioning an alignment tube in a containment vessel and loading a venting apparatus.

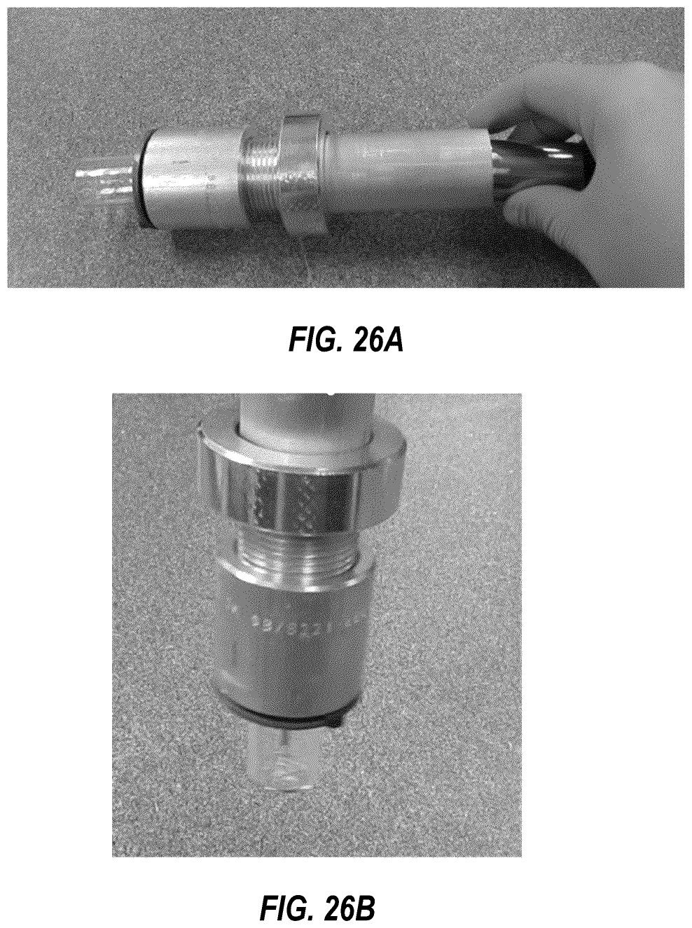

FIG. 26A illustrates loading a venting needle into an alignment tube, using the implementation shown in FIGS. 25A-25F. FIG. 26B illustrates the venting needle and alignment tube of FIG. 26A aligned so that the force of gravity propels the venting needle through the foil cap.

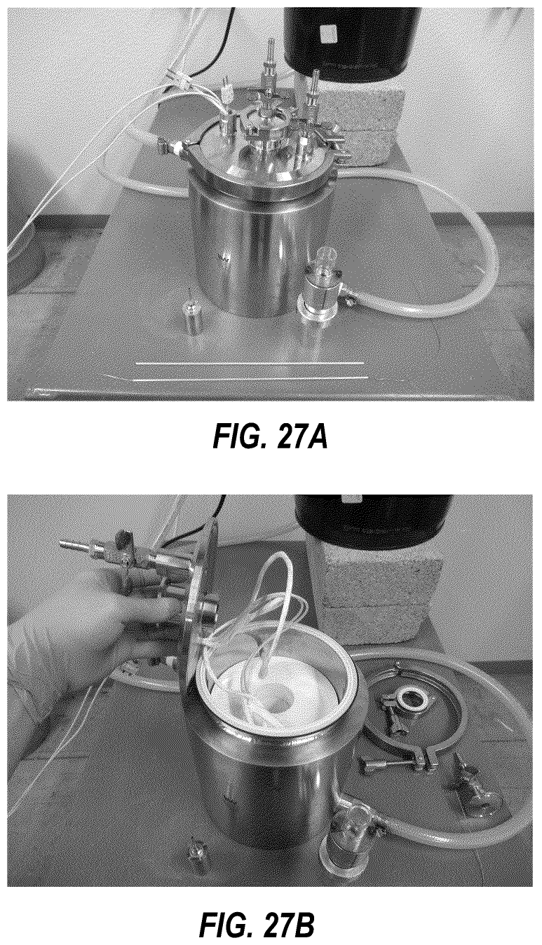

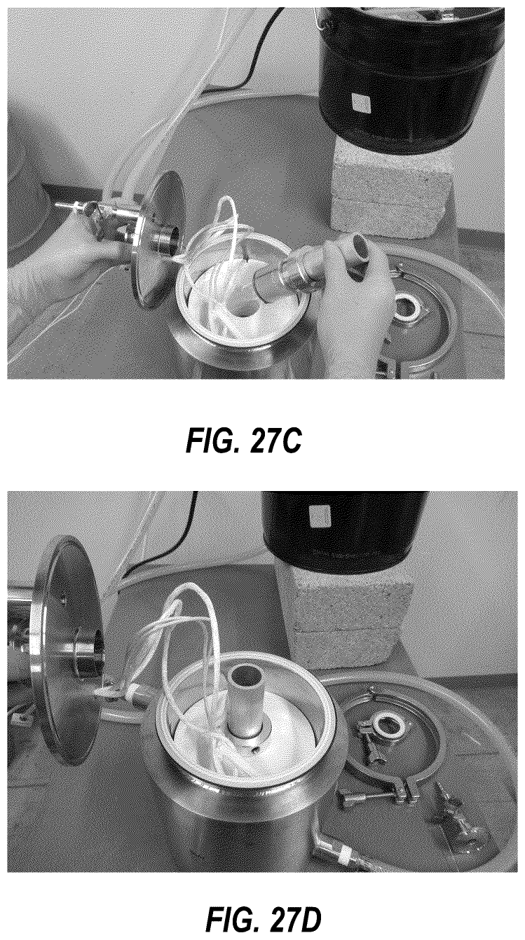

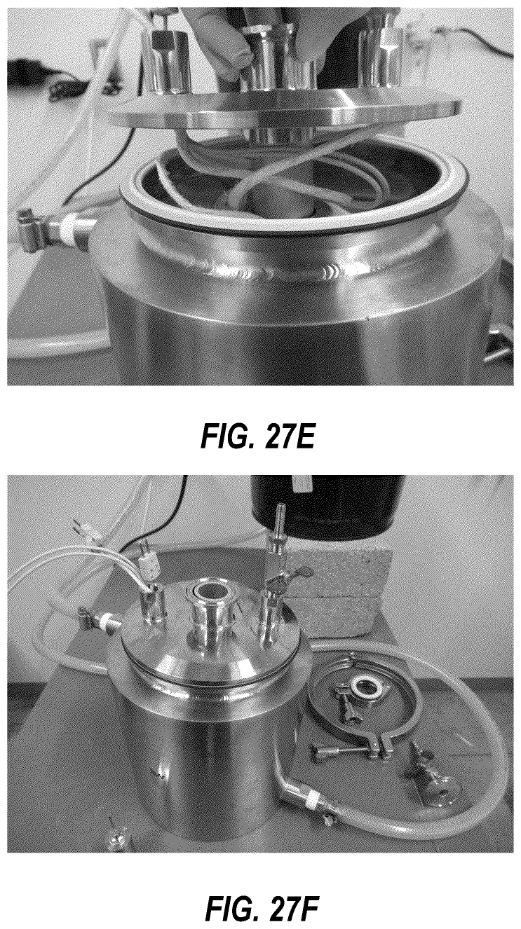

FIG. 27A illustrates an experimental implementation including a containment vessel. FIG. 27B illustrates the containment vessel of FIG. 27A in an open position. FIG. 27C illustrates inserting an alignment tube into the containment vessel. FIG. 27D illustrates the alignment tube in the containment vessel. FIG. 27E illustrates closing the containment vessel. FIG. 27F illustrates the containment vessel in a closed position.

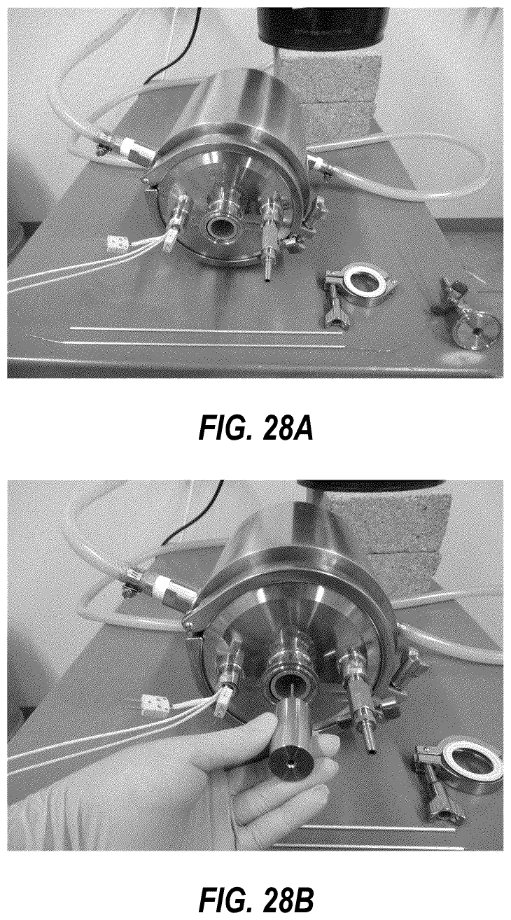

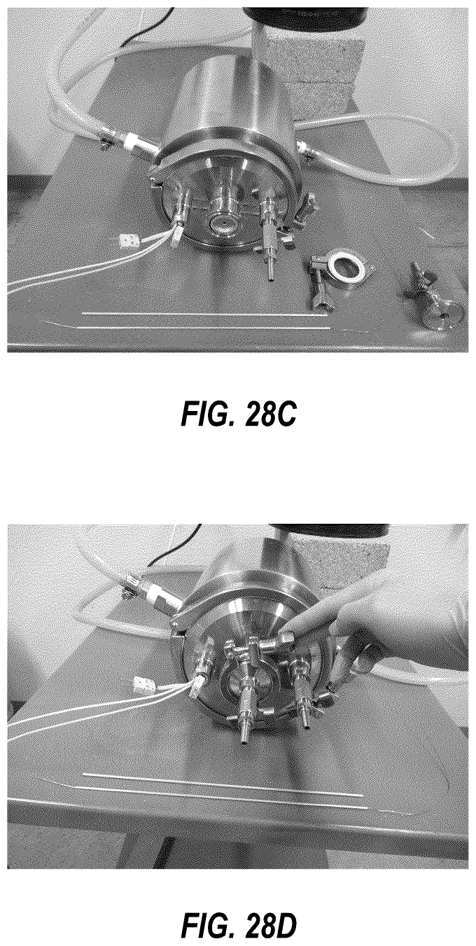

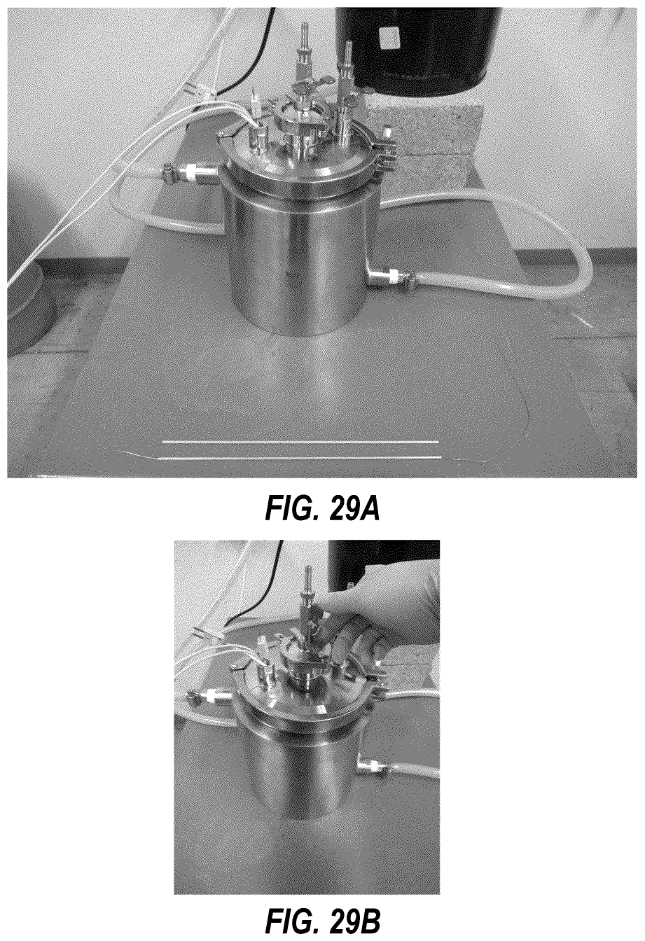

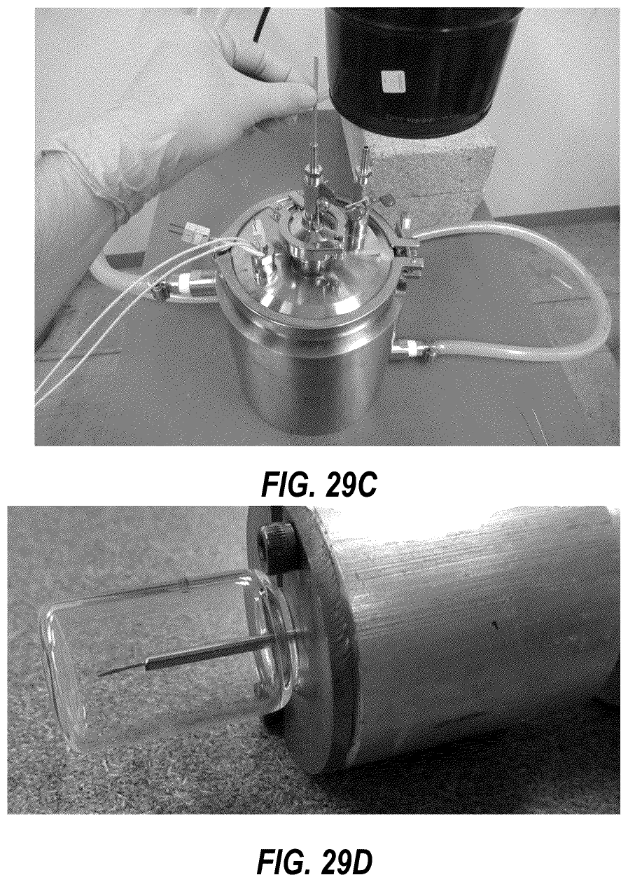

FIG. 28A illustrates the experimental implementation of FIGS. 27A-27F rotated 90 degrees. FIG. 28B illustrates a venting cylinder/needle loaded into the alignment tube. FIG. 28C illustrates the venting apparatus loaded and the vessel sealed with tri-clamp fittings horizontally. Vents in the containment vessel can be closed, and any electrical input can be sealed with silicon sealant and/or liquid electrical tape. FIG. 28D illustrates the containment vessel with the tri-clamp fittings attached. FIG. 29A illustrates the containment vessel turned upright to allow the weighted piston to drop onto the sample vessel and pierce the capsule seal.

FIG. 29B illustrates venting the containment vessel. FIG. 29C illustrates opening a center isolation valve to insert an extraction tube and sampling wire. Optionally the sampling wire is made from SS-304. FIG. 29D illustrates sampling the capsule.

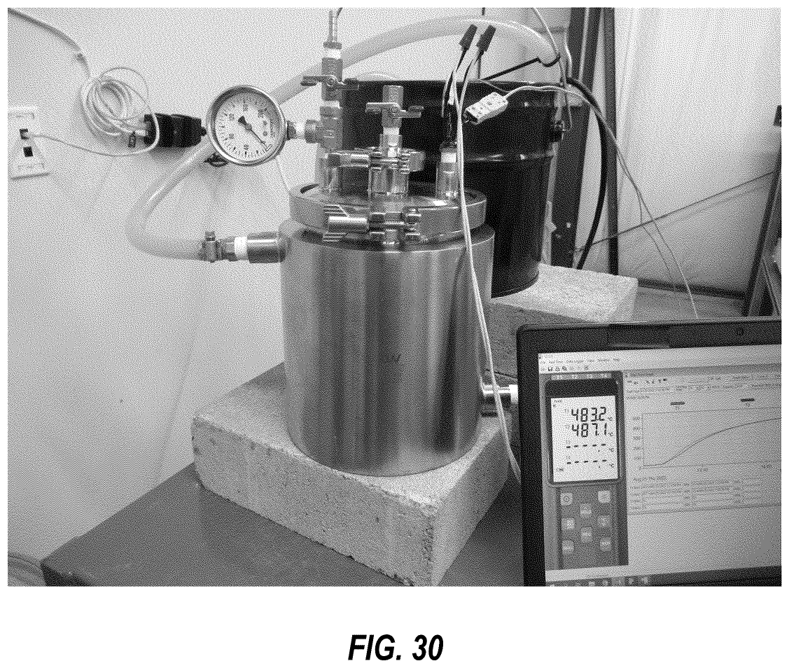

FIG. 30 illustrates monitoring the heating and pressure of an example containment vessel during an experiment.

### Example 3

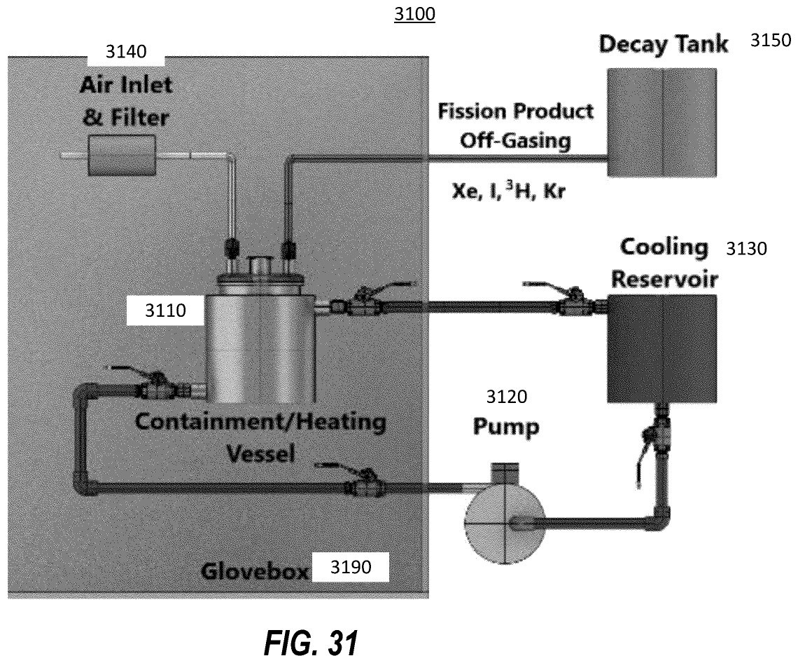

Implementations of the present disclosure include methods and systems for processing radioactive materials. FIG. 31 illustrates a processing system 3100 including a containment vessel 3110, a pump 3120, a cooling reservoir 3130, an air inlet and filter 3140, and a decay tank 3150 for fission off gassing. Optionally, any or all of the components shown in FIG. 31 can be placed in a glovebox 3190. In the example implementation shown in FIG. 31, the air inlet and filter 3140 and containment vessel 3110 are inside the glovebox 3190.

Implementations of the present disclosure include systems and methods to evaluate the feasibility of a radioactive tracer dilution (RTD) method of molten salt mass determination for accounting total mass of fuel salt in advanced liquid fueled molten salt systems. Implementations of the present disclosure also include methods of irradiating a real fuel bearing salt at a small research reactor, to evaluate the RTD method.

Alternatively or additionally, systems and methods described herein can be used to validate the RTD method for mass determination of fuel bearing molten salt at a small scale to evaluate the possibilities of its deployment in nuclear material accounting (NMA) scenarios such as those in advanced LFMSRs. Alternatively or additionally the systems and methods described herein can be used to address various measurement challenges that hinder the accurate determination of salt mass by RTD and/or to provide first hand experimental data to support RTD method for NMA in LFMSRs.

An example method according to the present disclosure can include preparing a small fuel bearing salt sample and irradiate it at a research reactor, mixing fuel bearing salt with a radioactive tracer of known activity, sampling the irradiated fuel bearing salt, measuring the mass and activity of each salt, sampling while correcting for any interference to tracer activity, and/or using the mass to activity ratio and the known original tracer activity, while accounting for any tracer burnup during irradiation, to calculate the known original fuel salt mass.

Implementations of the present disclosure include procedures for irradiation of fuel bearing salt sample and including the design of a salt container capsule, a salt heating apparatus and in situ gamma spectroscopy system, along with comprehensive radiation safety analyses is under preparation.

Implementations of the present disclosure include salt preparations. 13.8 g of MgCl₂ KCl UCl₃ fuel salt can be used. High purity 99.99% MgCl₂ and KCl were acquired through commercial vendors and mixed with a 0.3:0.7 molar ratio in terms of MgCl₂ KCl. The UCl₃ concentration was determined to be 15.15 wt % with ²³⁵ U concentration at 0.07 wt % and ²³⁸U concentration at 10.38 wt %. The FeCl₂ concentration was 0.045 wt % The total uranium in the sample had an overall average of 10.45 wt %

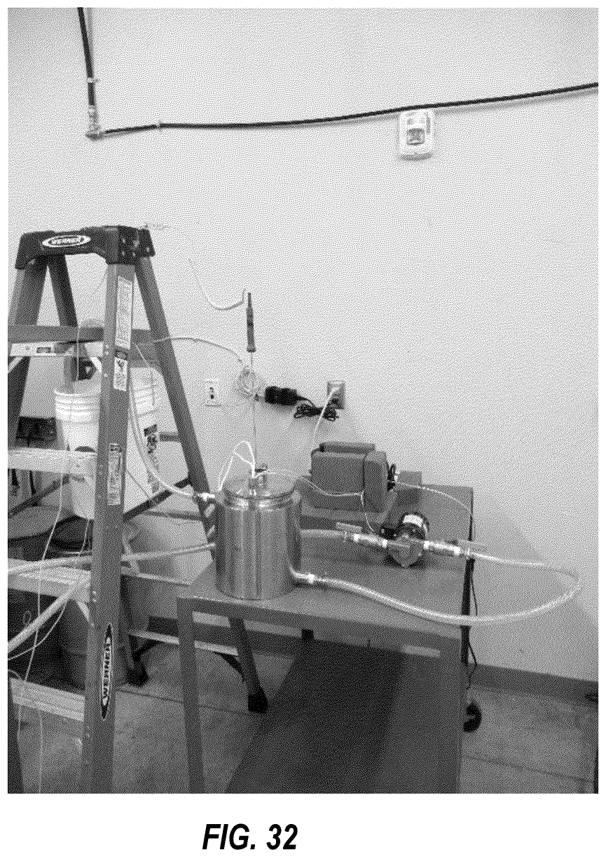

Tests were performed on a flexible graphite (grafoil) gasket. FIG. 32 illustrates an experimental setup, according to implementations of the present disclosure. The external temperatures when the interior is at 500 degrees Celsius were 83-110 degrees Fahrenheit at the body/neck/center, and 110 degrees Fahrenheit at the bottle cap. The external temperatures when the interior is 700 degrees Celsius were 82-90 degrees Fahrenheit at the body/neck/center, 100-200 degrees Fahrenheit at the bottle cap, and 100 degrees Fahrenheit at the return water line.

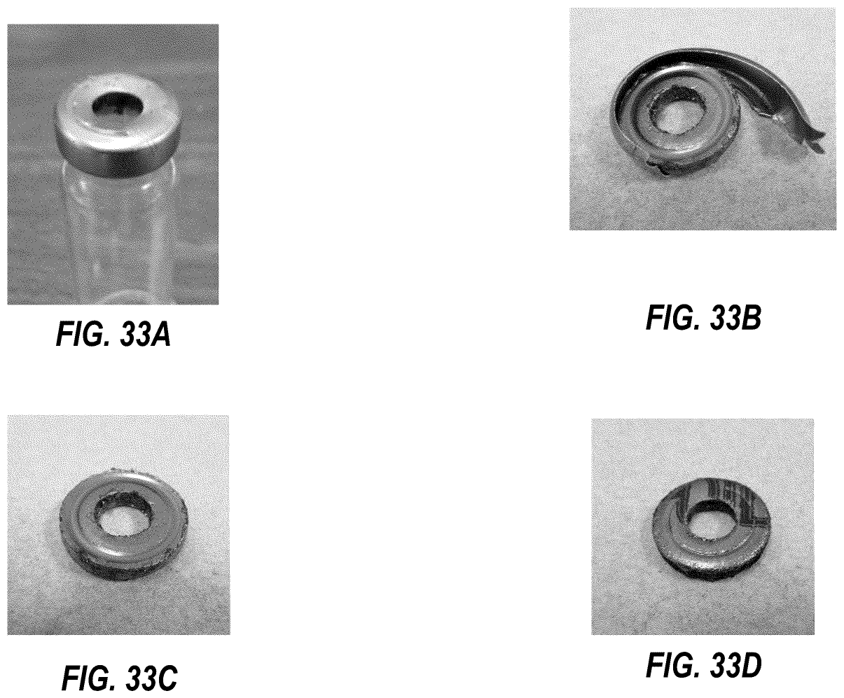

FIG. 33A illustrates a cap after 1 hour at 700 degrees Celsius based on the internal chamber temperature. FIG. 33B illustrates a grafoil gasket after 1 hour at 700 degrees Celsius based on the internal chamber temperature. FIG. 33C illustrates a second view of a grafoil gasket after 1 hour at 700 degrees Celsius based on the internal chamber temperature. FIG. 33D illustrates a third view of a grafoil gasket after 1 hour at 700 degrees Celsius based on the internal chamber temperature. Optionally, the gasket can be a PTFE gasket rated up to 260 degrees Celsius.

The study of the example implementation included MCNP calculations based on 100 cycles with 10⁷ particles per sample. Flux values in the sample were determined to be 2.0×10¹³ n/cm²/sec with an error of 1.49% within a volume of 4.119 cm³ for 1 hour at 450 kWₜₕ. Isotopes of interest were noted including 154Eu which shares a gamma energy around the same 1274.54 keV peak as the ²²Na tracer. The expected quantity of ¹⁵⁴Eu after a 1-hour burn would be equivalent to 3.8×10⁻¹⁷ grams producing an approximate activity of 1×10⁻⁵ μCi.

Calculations using 10 micrograms of ²²NA tracer proved to be much higher in activity levels than necessary. Therefore, another burn-up analysis was conducted with MCNP using an initial quantity of 0.016 micrograms. This resulted in 1.596×10⁻⁸ grams with an activity of 99.7 μCi after 3 days. This activity level was deemed to be much more manageable for post-irradiation analysis. Guided by these results, the amount of ²²Na tracer to be added in the actual irradiation experiment could be greatly reduced.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
Cao, Lei, Josh Jarrell, Susan White, Kevin Herminghuysen, Andrew Kauffman, Douglas E. Hardtmayer, and Jeff Sanders. “A radioactive tracer dilution method to determine the mass of molten salt.” Journal of Radioanalytical and Nuclear Chemistry 314, no. 1 (2017): 387-394.
D. Hardtmayer, K. Herminghuysen, S. White, et al (2018) “Determination of molten salt mass using 22Na tracer mixed with 154Eu and 137Cs.” J Radioanal Nucl Chem 318:457463. https://doi.org/10.1007/s10967-0185995-x
M. VanZile, E. Gordon, P. Kandlakunta, A. Kauffman, M. Bisbee, S. Li, M. Simpson, S. Shahbazi, L. R. Cao, “Design of Fuel Salt Irradiation for Fission Products Gamma Spectroscopy and Off-Gassing Study,” ANS Transactions Winter 2022 Meeting.

What is claimed is:

1. An extraction system, the system comprising:
a main body having a longitudinal axis, a first body end, and a second body end opposite and spaced apart along the longitudinal axis from the first body end, wherein the first body end includes a collar coupler for coupling the main body to a pierceable portion of a container defining a container chamber, the first body end defining a first channel extending along the longitudinal axis toward the second body end such that the first channel is in fluid communication with the pierceable portion when the container is coupled to the coupler, wherein the second body end defines a second channel extending along the longitudinal axis toward the first body end such that the second channel is in fluid communication with the first channel; and
a piston having a first piston end and a second piston end opposite and spaced apart from the first piston end, the piston defining a piston channel extending from the first piston end to the second piston end, the piston including a hollow needle extending from the first piston end and in fluid communication with the piston channel,
wherein the piston is slidably disposable within the second channel such that, when the piston slides through the second channel toward the first body end, the hollow needle of the piston extends through the first channel to pierce the pierceable portion of the container such that the container chamber of the container is in fluid communication with the second body end through the hollow needle, the piston channel, and the second channel.

2. The system of claim 1, wherein, when the main body is oriented such that the longitudinal axis is parallel to a gravitational axis and the first body end is below the second body end, the piston is slidable through the second channel toward the first body end by gravity.

3. The system of claim 1, wherein the pierceable portion of the container is a foil cap.

4. The system of claim 1, further comprising a containment vessel, the containment vessel comprising an opening configured to couple to the main body.

5. The system of claim 4, further comprising a heater disposed within the containment vessel.

6. The system of claim 5, wherein the containment vessel further comprises a cooling jacket.

7. The system of claim 5, further comprising a sensor disposed within the containment vessel.

8. The system of claim 1, further comprising a tube disposed in the hollow needle of the piston.

9. The system of claim 8, further comprising a rod disposed within the tube and configured to retrieve a sample from the container through the hollow needle of the piston.

10. The system of claim 1, wherein the collar coupler includes two or more collar portions are movable radially inwardly to contact a portion of the container.

11. A method of processing a material, the method comprising:
providing the material in a container, wherein the container comprises a pierceable portion;
coupling the container to a main body, wherein the main body comprises a piston configured to pierce the pierceable portion of the container, the piston comprising a hollow needle;
coupling the main body to a containment vessel;
heating the container to produce a processed material;
piercing the pierceable portion of the container using the piston; and
retrieving the processed material.

12. The method of claim 11, wherein the processed material comprises tritium, and a radioactive salt.

13. The method of claim 12, wherein piercing the pierceable portion of the container comprises rotating the main body.

14. The method of claim 13, wherein the main body is oriented so that the piston is pulled toward the pierceable portion of the container by gravity.

15. The method of claim 13, wherein retrieving the processed material comprises inserting a tube or wire through the hollow needle.

16. The method of claim 13, wherein retrieving the processed material comprises venting a gas through the hollow needle.

17. The method of claim 15, wherein the method further comprises purging the container.

18. The method of claim 15, wherein purging the container comprises adding an inert gas to the container.

19. The method of claim 18, wherein the inert gas comprises argon.

20. The method of claim 11, further comprising cooling at least one of the main body, the container, or the material using a cooling jacket.
